(19) United States
(12) Patent Application Publication
(10) Pub. No.: US 2004/0094589 A1
(43) Pub. Date: May 20, 2004

(54) Collapsible insulated portable storage carrier with security flap

(76) Inventor: Phillip James Fricano, Scottsdale, AZ (US)

Correspondence Address: Phillip James Fricano, P.O. Box 4571, Scottsdale, AZ, 85261-4571, US

(21) Appl. No.: 10/715,049

(22) Filed: Nov. 17, 2003

Related U.S. Application Data
(60) Provisional application No. 60/427,822, filed on Nov. 20, 2002.

(51) Int. Cl. B60R 7/00; B60R 9/00; B60R 11/00

(52) U.S. Cl. 224/404; 224/556

(57) ABSTRACT

A carrier (10A and 10B) made of a flexible, rigid insulating material consisting of a longitudinal flap (16) with integral lobe (18) to enable the carrier to be secured onto the bed (30) of a pickup truck by trapping said lobe within the gap (34) between the pickup truck bed and truck tailgate (28). The top panel (42) and bottom panel (44) each consisting of zipper pulls (22A, 22B, 22C, 22D) and said panel attachment onto common back panel (12) to permit opening and closing and serving further purpose as to permit complete collapsing and folding of the carrier. The carrier actually consisting of two identical mirror image configured carriers for maximum consumption of space generated by the width and height of said truck bed, and distance between said pickup truck tailgate and truck tubular-bed-extender (36).

### CROSS-REFERENCE TO RELATED APPLICATIONS

Based upon provisional patent application Ser. No. 60/427,822

### BACKGROUND

1. Field of the Invention

The present invention relates to containing, protecting, transporting and securing articles placed in a vehicle, and in particular a pickup truck.

2. Description of Prior Art

Pickup trucks notoriously have little or no space for storage. In particular, the bed of a pickup truck is usually utilized to much less than capacity. A partial load creates an opportunity for articles such as groceries, tools, camping gear and so forth to be tossed about or even ejected from the truck's bed. The problem of providing a means of storing, and transporting articles in the bed of a pickup truck was solved by inventing a rigid container. The container, made either of metal or plastic, is cumbersome, heavy, timely to install and remove, consumes considerable space to store, and has little insulating value. Typically, the rigid container is dimensioned and configured so as to span the width of a pickup truck bed, suspended and attached to the vertical side walls. The container is positioned adjacent to the truck cab. Consequently, standing adjacent to the truck bed, it is ergonomically difficult for a person to reach into the container to load or remove articles.

### SUMMARY INCLUDING OBJECTS AND ADVANTAGES

In accordance with the present invention a collapsible insulated portable storage carrier with a security flap and opening panels top and bottom to permit folding.

### OBJECTS AND ADVANTAGES

Accordingly, several objects and advantages of my invention are:

(a) a storage carrier that is actually comprised of two mirror-image shaped carriers, each independent of the other and therefore can be used in pair or separately.

(b) a storage carrier that is comprised of top and bottom hinged, opening panels, each panel containing a zipper with two zipper pulls. In passing a lock through each pair of zipper pull holes, the container is sealed closed.

(c) a storage carrier that is comprised of top and bottom opening panels to permit collapsing and folding for space saving storage and packaging.

(d) a storage carrier that is comprised of a removable partition.

(e) a storage carrier that is comprised of a durable, collapsible and light weight fabric

(f) a storage carrier that is comprised of a retractable shoulder strap for easy carrying and transporting.

(g) a storage carrier that is comprised of a foam plastic structure for providing rigidity and thermal insulation.

(h) a storage carrier that is comprised of a lobed flap to enable securing the carrier onto the body of the pickup truck.

Still further objects and advantages will become apparent from a consideration of the ensuing description and accompanying drawings.

### BRIEF DESCRIPTION OF THE DRAWINGS

FIG. 1A is a perspective view of mirror image configured carriers showing the security hold-down flap with longitudinal lobe.

FIG. 1B shows zipper pulls in proximal position to permit attachment of a security lock.

FIG. 2 is a perspective view of mirror image configured carriers placed into position onto a pickup truck bed and showing the security hold-down flap with longitudinal lobe positioned between truck bed and open tailgate.

FIG. 3 is a perspective view of one carrier showing the longitudinal hold-down flap with longitudinal lobe trapped intermediate the truck bed and tailgate.

FIG. 4A is a perspective view of mirror image configured carriers showing one carrier with the top panel open to expose the removable partition, and showing the attachment of the carriers onto a truck tubular-bed-extender devise.

FIG. 4B is a side view of the carrier showing security straps attached onto the tubular-bed-extender and longitudinal flap with lobe trapped between the truck bed and closed tailgate.

FIGS. 5A to 5E show the procedure of folding one of the mirror image configured carriers.

### REFERENCE NUMERALS

10A storage carrier with mirror image configuration to storage carrier 10B

10B storage carrier with mirror image configuration to storage carrier 10A

12 back vertical panel of storage carrier

14 top and bottom panel skirt (to protect and conceal zippers)

16 hold-down flap

18 longitudinal lobe (at distal end of hold-down flap)

20 removable insulated partition

22A top distal zipper pull

22B top mesial zipper pull

22C bottom distal zipper pull

22D bottom mesial zipper pull

24 attachment strap

26 shoulder strap

28 truck tailgate

30 truck bed

32 truck body sidewall

34 gap intermediate truck tailgate and bed

36 truck tubular-bed-extender

38 curved vertical panel

40 straight vertical panel

42 top panel

44 bottom panel

46 zipper teeth along interface of top panel and side panels

48 zipper teeth along interface of bottom panel and side panels

### PREFERRED EMBODIMENT—DESCRIPTION

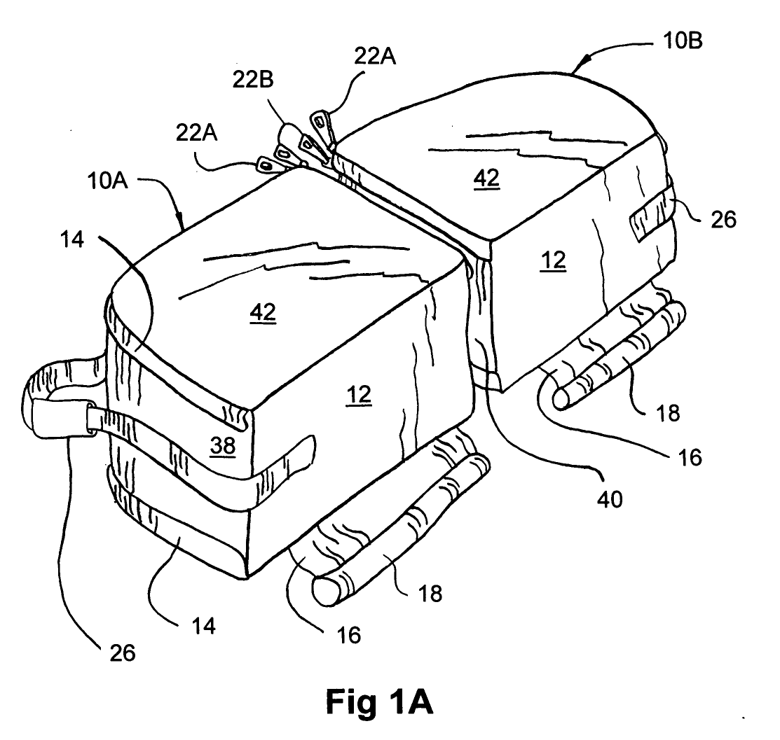

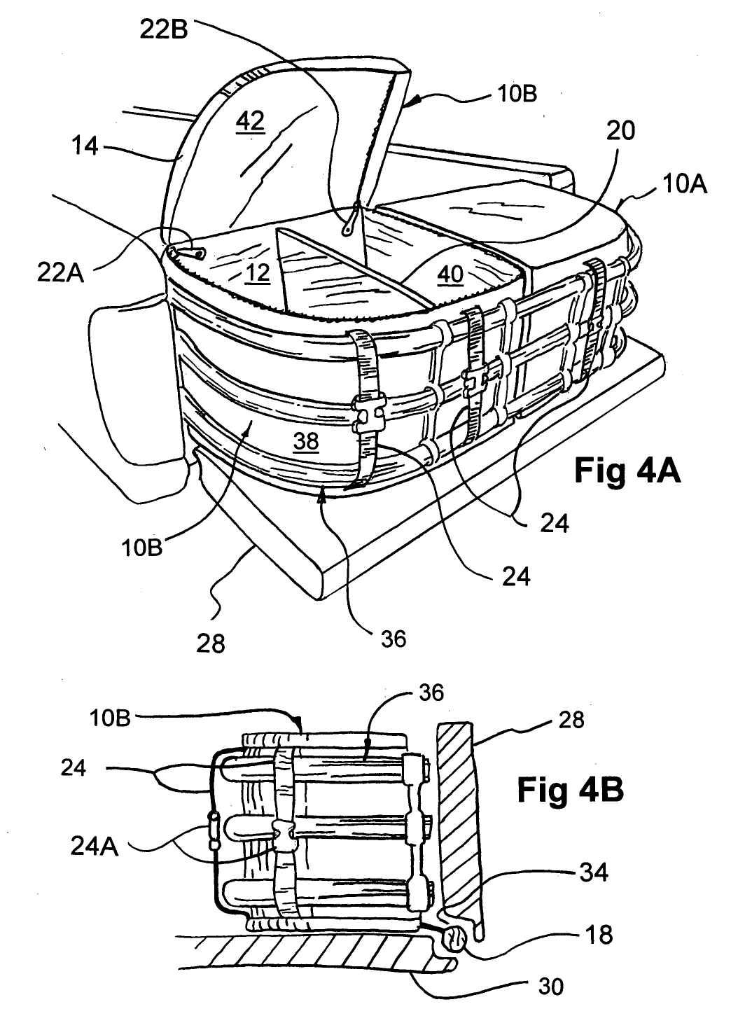

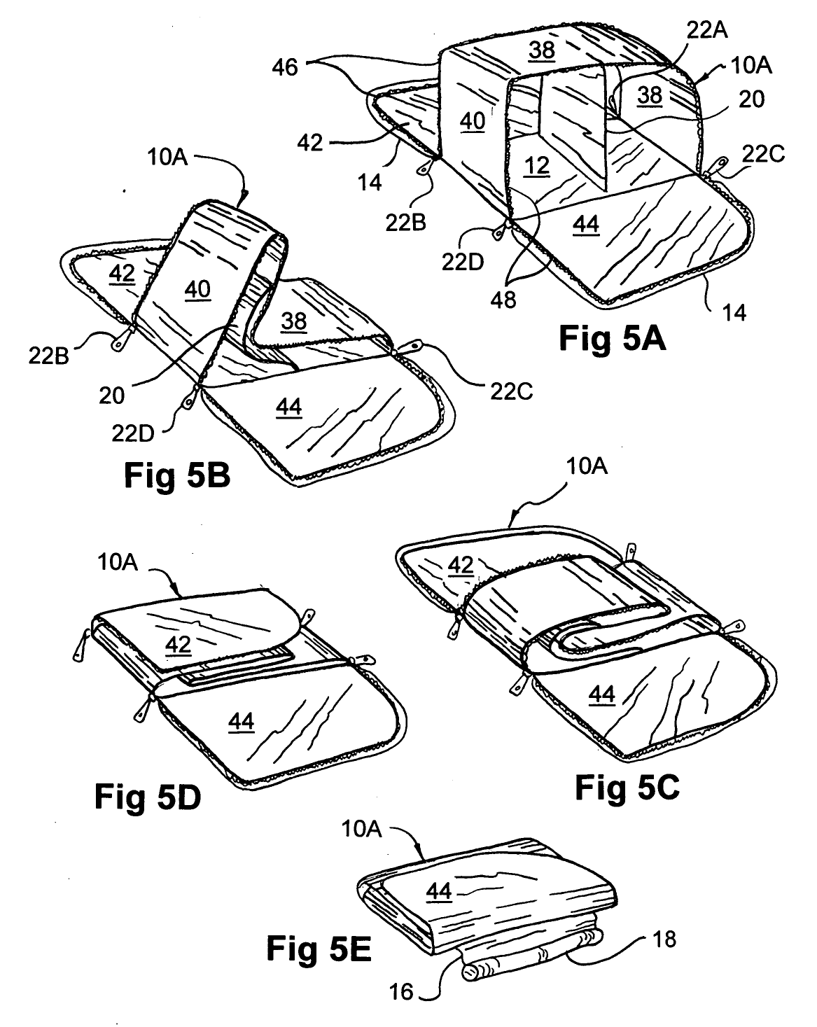

A preferred embodiment of the storage carrier is illustrated in FIG. 1A (back view), FIG. 4A (front view), and FIG. 5A (laying on back panel 12). The storage carrier is actually comprised of two identical mirror image independent carriers 10A and 10B. In having carriers 10A and 10B identical in size they consume a minimum volume when folded flat and placed congruently one on top of the other for storage and retail packaging. As illustrated in FIG. 5A the carrier is comprised of a planer back panel 12, an arcuate front panel 38, a planer side panel 40, a planer top panel 42, and planer bottom panel 44. Top and bottom panels are sewn onto the back panel so as to provide a hinge. A zipper 22 with two zipper pulls 22A and 22B are provided for easy closure and the attachment of a security lock (FIG. 1B). A zipper 22 is also provided with two zipper pulls 22C and 22D on bottom panel for easy closure and the attachment of a security lock. Zipper 22 at both the top and bottom perimeters is concealed and protected by panel skirt 14 which is sewn into position simultaneously when the zippers are sewn onto the top and bottom panels. All carrier body panels are comprised of three layered components: Exterior and interior body panels made of durable, ultra violet resistant fabric such as nylon or the like; intermediate the exterior and interior body panels is a membrane made of cross-linked polyethylene foam plastic material for thermal and structural properties. The intermediate body panel provides rigidity when the carrier is erected for use, and memory for retention of shape upon having been collapsed for retail packaging and consumer storage. Removable partition 20 subtended between back panel 12 and front panel 38 is attached by means of “Velcro” tm fastening material sewn at each end of the partition and mating with “Velcro” tm fastening material sewn onto the subtending panels 12 and 38. As a means of securing the carrier onto the bed of a pickup truck to prevent pilferage or inadvertent ejection, longitudinal flap 16 with lobe 18 is provided. The lobe is comprised of cotton cording or the like and is sewn into the nylon longitudinal flap. The length of the flap opposite the lobe is sewn along the length and at the juncture of the back and bottom panels. Adjustable shoulder strap is sewn onto and subtended from the body back panel to the side panel horizontally and at mid height (FIG. 1A).

### PREFERRED EMBODIMENT—OPERATION

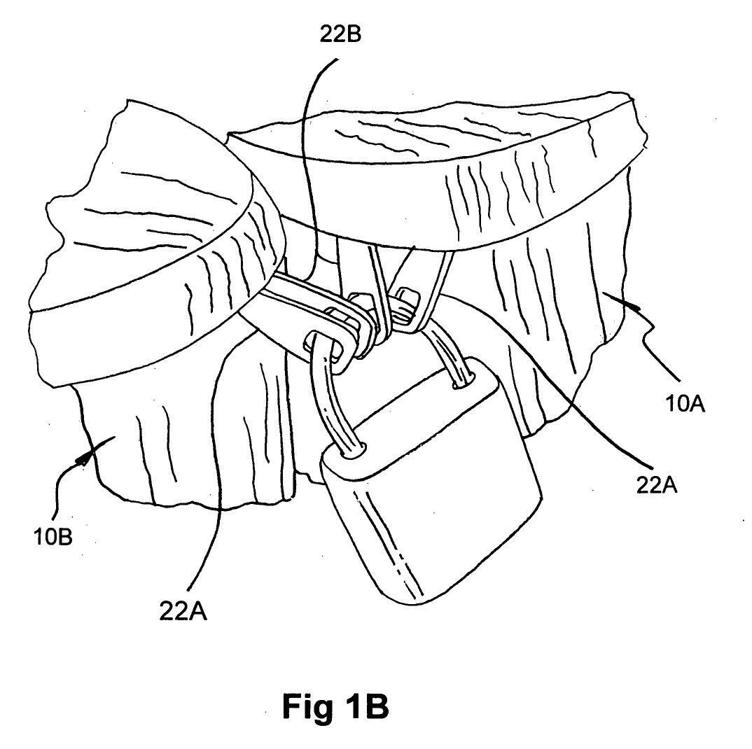

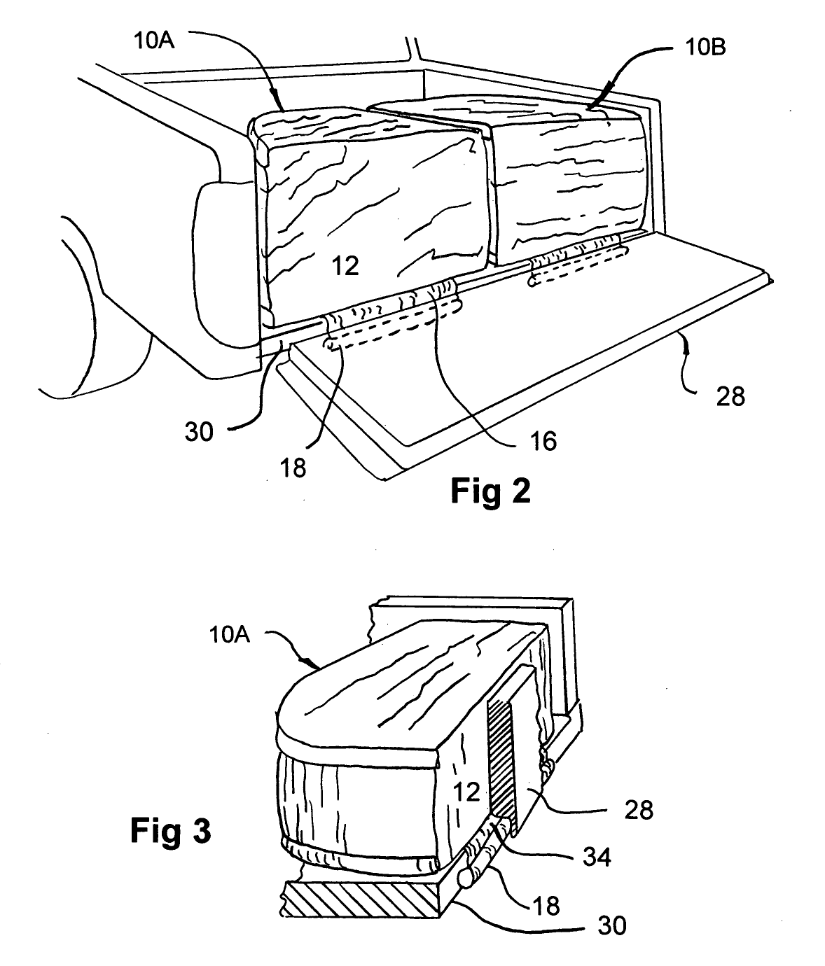

As a means of packaging, shipping, and storing the carriers, they are folded as shown in FIGS. 5A through 5E. As a means of simplification, steps in folding carrier 10A only are explained (steps for folding carrier 10B are the same as 10A). FIG. 5A shows the carrier setting on back panel 12 with top panel 42 and bottom panel 44 open. Zipper pulls 22A, 22B, 22C, and 22D are positioned as indicated. When zipper pulls 22A and 22B are traversed towards one another along the length of their zipper teeth 46, the top panel becomes closed. The hole located in each zipper pull permits attachment of a lock to safeguard the carrier contents. When zipper pulls 22C and 22D are traversed toward one another along their zipper teeth 48, the bottom panel becomes closed. FIG. 5B shows side panel 38 collapsed inwardly and onto back panel 12. In collapsing panel 38, the partition 20 collapses also. Next, folding side panel 40 onto panel 38 fully collapses the carrier. FIG. 5C shows the full collapse. FIG. 5D shows folding top panel 42. FIG. 5E shows folding bottom panel 44 and reveals hold down flap 18. Setting up or erecting the carriers is performed by reversing these steps shown in FIGS. 5A through 5E. When the carriers are set up and utilized adjacent to each other as shown in FIG. 1A, zipper pulls 22A and 22B for top panels, and zipper pulls 22C and 22D for bottom panels are juxtaposed mesial carriers 10A and 10B. Positioning the zipper pulls in this location permits for the attachment of a lock when the lock is engaged through each zipper pull hole as shown in FIG. 1B. Carriers 10A and 10B are each equipped with hold-down flap 16 comprised of a longitudinal lobe 18. When either or both carriers are set onto a pickup truck bed (FIG. 2 and FIG. 3) so that the longitudinal lobe is positioned along gap 34, the carriers are secured between the truck bed and tailgate when the tailgate is closed (raised). In addition to utilizing the carriers on a pickup truck bed, the carriers are suitable for use on a car seat. The longitudinal lobe can be trapped by simply pushing the lobe into and along the crevice between a car's seat back and seat bottom.

Some trucks are equipped with a tubular-bed-extender 36 as shown in FIG. 4A and FIG. 4B. When the truck tailgate is horizontal (resting downwardly in the open position), the tubular-bed-extender is positioned to set onto the tailgate thereby increasing the load capacity dimensionally (extending the bed). In this extended position, the lobe serves no purpose because it is not trapped between the tailgate and bed. As a means of securing the carrier in this mode, straps 24 are positioned to encompass the tubes of the bed-extender by means of snap 24A, buckle or the like. When the truck bed-extender is positioned in a retracted mode (FIG. 4B) and the tailgate is in the upward (closed) position, the load capacity is dimensionally decreased. In this mode, the carrier is secured by both the straps and the longitudinal flap with lobe.

### Conclusions, Ramifications, and Scope

Accordingly, it can be seen that the carrier I have invented provides a means for attachment onto the bed of a pickup truck to prevent pilferage and the inadvertent ejection from the vehicle. This is accomplished by means of a longitudinal hold down flap with a lobe. Furthermore, the carrier has the additional advantages in that

it is lightweight and consists of a shoulder strap for ease in transportability;

it is comprised of a removable insulated partition for sub-organizing;

it is comprised of two zipper pulls on top and bottom panels for attachment of a security lock which can be installed one carrier or shared with both;

it is comprised of zipper pulls on top and bottom panels to allow for folding when packaging or storing, greatly reducing the volume the carrier consumes;

it is thermally insulated to protect contents such as food;

it is comprised of security hold down straps for those pickup trucks equipped with a tubular-bed-extender;

it is comprised of a material that allows for structural rigidity and will flex or deflect if necessary;

Accordingly, it can be seen that although the description above contains many specificities, these should not be construed as limiting the scope of the invention but as merely providing illustrations of some of the presently preferred embodiments of this invention. Various other embodiments and ramifications are possible within it's scope. For example, “Velcro” tm fasteners can be utilized in lieu of zippers; and a vinyl liner can be installed to occupy the entire volume inside the carrier for containing ice, allowing the carrier to be utilized as a cooler.

Thus the scope of the invention should be determined by the appended claims and their legal equivalents, rather than by the examples given.

What is claimed is:

1. A carrier for holding articles within the bed of a pickup truck, comprising:
1. a longitudinal flap intermediate and traversing the bottom panel and back panel.
2. a longitudinal lobe, integrated along the length of the distal end of the longitudinal flap, which becomes trapped along the length of the gap between the truck bed and truck tailgate providing a means of securing the carrier to resist pilferage and inadvertent ejection.
3. a top panel and bottom panel hinged onto common back panel with zipper closures to permit for full collapse and folding of the carrier.
4. two zipper pulls on top panel and bottom panel to permit for attachment of a lock for security.
